(19) United States
(12) Patent Application Publication
(10) Pub. No.: US 2026/0149978 A1
(43) Pub. Date: May 28, 2026

(54) SYSTEMS AND METHODS OF WIRELESS COMMUNICATION SYSTEMS USING MULTI-LAYER MODELS

(71) Applicant: APPLE INC., Cupertino, CA (US)

(72) Inventors: Fangli Xu, Beijing (CN); Haijing Hu, Los Gatos, CA (US); Zhibin Wu, Los Altos, CA (US); Peng Cheng, Beijing (CN); Yuqin Chen, Beijing (CN); Ralf Rossbach, Munich (DE); Naveen Kumar R Palle Venkata, San Diego, CA (US); Alexander Sirotkin, Hod Hasharon (IL); Ping-Heng Kuo, London (GB)

(21) Appl. No.: 19/122,128

(22) PCT Filed: Nov. 3, 2022
(86) PCT No.: PCT/CN2022/129627

§ 371 Date: Apr. 17, 2025

(51) Int. Cl. H04W 16/32; H04W 48/08; H04W 74/0833

(52) U.S. Cl. CPC H04W 16/32; H04W 48/08; H04W 74/0833

(57) ABSTRACT

Systems and methods for the operation of wireless communications systems using multi-layer models are disclosed. A multi-layer model operated by a wireless communication system includes a coverage layer and one or more data layers. A UE of the wireless communication system is operable to connect to each of the coverage layer and one or more of the data layer(s). In some cases, the UE uses the coverage layer for connection-related communications (e.g., for the maintenance of a connection with the network), while the associated data layer(s) to which the UE connects are used by the UE for the communication of, e.g., user-plane data with the network. In some cases, the coverage layer and the one or more data layers are provided by distinct frequency carriers within a single logical cell. In other cases, the each layer is provided through distinct one(s) of a set of coordinated cells.

### TECHNICAL FIELD

This application relates generally to wireless communication systems, including wireless communication systems using multi-layer models.

### BACKGROUND

Wireless mobile communication technology uses various standards and protocols to transmit data between a base station and a wireless communication device. Wireless communication system standards and protocols can include, for example, 3rd Generation Partnership Project (3GPP) long term evolution (LTE) (e.g., 4G), 3GPP new radio (NR) (e.g., 5G), and Institute of Electrical and Electronics Engineers (IEEE) 802.11 standard for wireless local area networks (WLAN) (commonly known to industry groups as Wi-Fi®).

As contemplated by the 3GPP, different wireless communication systems standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, global system for mobile communications (GSM), enhanced data rates for GSM evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements universal mobile telecommunication system (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC), while NG-RAN may utilize a 5G Core Network (5GC).

Frequency bands for 5G NR may be separated into two or more different frequency ranges. For example, Frequency Range 1 (FR1) may include frequency bands operating in sub-6 gigahertz (GHz) frequencies, some of which are bands that may be used by previous standards, and may potentially be extended to cover new spectrum offerings from 410 megahertz (MHz) to 7125 MHz. Frequency Range 2 (FR2) may include frequency bands from 24.25 GHz to 52.6 GHz. Note that in some systems, FR2 may also include frequency bands from 52.6 GHz to 71 GHz (or beyond). Bands in the millimeter wave (mmWave) range of FR2 may have smaller coverage but potentially higher available bandwidth than bands in FR1. Skilled persons will recognize these frequency ranges, which are provided by way of example, may change from time to time or from region to region.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a model showing a coverage layer and a data layer of a wireless communications system, according to embodiments herein.

FIG. 2 illustrates a model 200 showing a coverage layer 202 and a data layer 204 of a wireless communications system, according to embodiments herein.

FIG. 3 illustrates a flow diagram for paging operation for a UE operating within a multi-layer model having a coverage layer and a data layer, according to embodiments herein.

FIG. 4 illustrates a flow diagram for SI reception at a UE operating within a multi-layer model having a coverage layer and a data layer, according to embodiments herein.

FIG. 5 illustrates a flow diagram for SI reception at a UE operating within a multi-layer model having a coverage layer and a data layer, according to embodiments herein.

FIG. 6 illustrates a flow diagram for the performance and use of an enhanced RRM measurement by a UE operating within a multi-layer model having a coverage layer and a data layer, according to embodiments herein.

FIG. 7 illustrates a flow diagram for the use of a RACH procedure by a UE operating within a multi-layer model having a coverage layer and a data layer, according to embodiments herein.

FIG. 8 illustrates a flow diagram for a connection recovery procedure by a UE operating within a multi-layer model having a coverage layer and a data layer, according to embodiments herein.

FIG. 9 illustrates a flow diagram for a handover procedure by a UE operating within a multi-layer model that performs handover from a first cell/first coordinated cell set to a second cell/second coordinated cell set, according to embodiments herein.

FIG. 10 illustrates a method of a UE, according to embodiments herein.

FIG. 11 illustrates a method of a UE, according to embodiments herein.

FIG. 12 illustrates a method of a UE, according to embodiments herein.

FIG. 13 illustrates a method of a UE, according to embodiments herein.

FIG. 14 illustrates a method of a UE, according to embodiments herein.

FIG. 15 illustrates a method of a UE, according to embodiments herein.

FIG. 16 illustrates a method of a RAN, according to embodiments herein.

FIG. 17 illustrates a method of a RAN, according to embodiments herein.

FIG. 18 illustrates an example architecture of a wireless communication system, according to embodiments disclosed herein.

FIG. 19 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

Some wireless communications systems use a network-controlled mobility framework. Under some such frameworks, it may be that the maintenance of zero millisecond (ms) interruption times in a manner such that performance is not degraded can only be achieved within one cell. In such systems, for cell level mobility, a connected UE first stops the use of transmissions to/from the cell or else it degrades performance during the mobility procedure.

Enhancements targeting these issues (e.g., the use of a dual active protocol stack (DAPS) as introduced in 5G) have been proposed. However, to date, such enhancements assume a network-controlled framework, ultimately causing them to be more complex than may be reasonably/desirably implemented.

Key performance indicator requirements for upcoming wireless communications systems (e.g., sixth-generation (6G) wireless communications) are desired to be improved/tightened. For example, in 6G systems, there may be a stringent quality of service (QoS) requirement for latency that end to end (E2E) latency is less than 1 ms for UE data communication in all cases/circumstances.

A UE-centric mobility concept should be considered (e.g., as opposed to the network-controlled mobility frameworks of prior wireless communications systems) in order to meet such requirements. Potential benefits of such UE-centric mobility models may include the ability to avoid data communication interruptions due to UE mobility, since it may be that the UE is not aware of a cell change (at least within a wider area). Further, on the network side, a CN node and a RAN node may be connected more closely architecturally. Benefits may also include the ability to avoid cell change related operation(s) corresponding to IDLE/INACTIVE/CONNECTED states as may be used in the wireless communication system (e.g., for handover, cell reselection, measurement, etc.), which may result in less power use at the UE.

It may be beneficial to achieve more efficient operation dynamically and/or semi-statically and finer granularity adaptation of transmissions and/or receptions using one or more network energy saving techniques. These techniques may be in time, frequency, spatial, and/or power domains, and may potentially use support/feedback from the UE and/or UE assistance information.

Some wireless communications systems may implement a synchronization signal block (SSB)/system information block (SIB)-less solutions in multi-carrier cases. For example, an SSB-less solution may be used for inter-band carrier aggregation (CA) when a UE is in connected mode. In some cases, this intra-band CA mechanism may be considered a starting point, with impacts and the use of paging to be considered.

### Embodiments of Multi-Layer Models

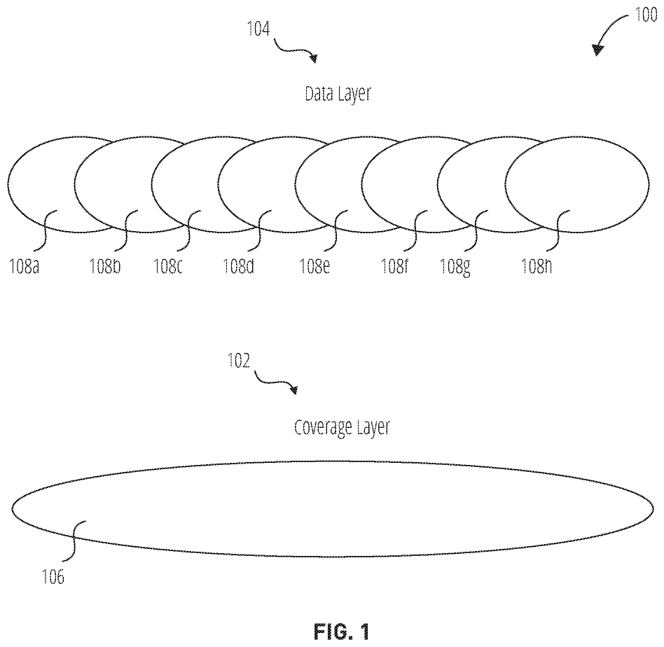

FIG. 1 illustrates a model 100 showing a coverage layer 102 and a data layer 104 of a wireless communications system, according to embodiments herein. It may be that in some wireless communications systems (e.g., 6G wireless communications systems), the arrangement of the coverage layer 102 and the data layer 104 together represent a single cell as understood/defined within that wireless communication system. This may be referred to herein as a “cell model” perspective. A multiple-layer cell model as discussed herein may be applied in a multiple carrier deployment environment.

Corresponding to the cell model perspective, the model 100 may correspond to a case where the coverage layer 102 is provided by a coverage carrier 106 operating on a first frequency, and where the data layer 104 is provided by a plurality of data carriers 108a through data carrier 108h each operating on a (same) second frequency.

Note that the use of a single coverage carrier 106 in the coverage layer 102 is given by way of example and not by way of limitation. It is contemplated that in some cases more than one coverage carrier (e.g., operating on the same frequency as the coverage carrier 106) may be used as part of the coverage layer 102. Further note that the number of the plurality of data carriers 108a through 108h is also given by way of example and not by way of limitation. It is contemplated that in some cases fewer (including, e.g., one) or more data carriers (e.g., operating on the same frequency as the data carriers 108a through 108h) may be used as part of the data layer 104.

In the case that multiple carriers are deployed within a coverage layer and/or a data layer (e.g., as in the data carriers 108a through 108h of the data layer 104), this may be transparent to the UE.

Finally, note that while only a single data layer 104 has been expressly illustrated, it is contemplated that one or more additional data layers may operate within the cell (e.g., in conjunction with the coverage layer 102 and the data layer 104). These one or more additional data layers may use one or more data carriers operating on, e.g., a frequency that is unique to that data layer.

Accordingly, under the cell model perspective, it may be understood that the cell includes multiple frequency layers, with one frequency layer for coverage (corresponding to the coverage layer 102) and N frequency layers for data communication (e.g., with each frequency layer of the N frequency layers corresponding to one of up to N data layers (having at least the data layer 104).

The coverage layer 102 may provide the cell with cell-specific common reference signal (RS) transmission, optionally with cell-level data communications, and may be used for cell-level mobility purposes.

Each data layer (e.g., the data layer 104) may be used for UE-dedicated data communications, UE-dedicated RS transmissions, and optionally cell level data communications.

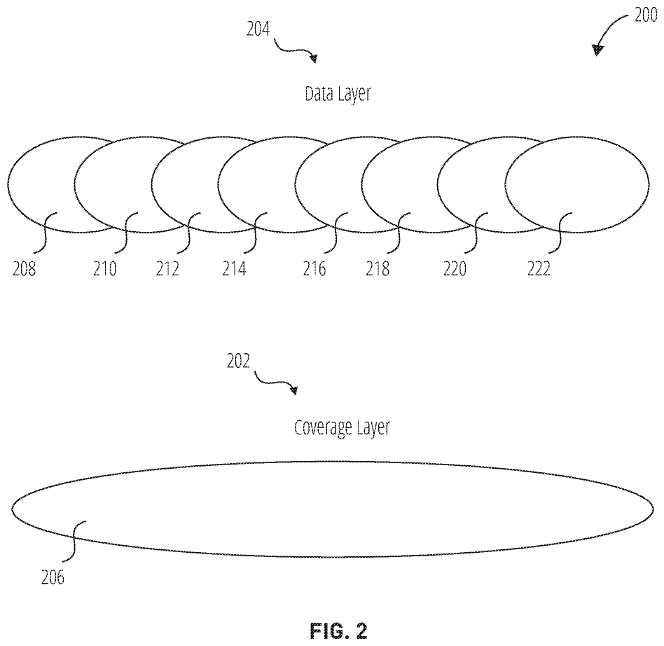

FIG. 2 illustrates a model 200 showing a coverage layer 202 and a data layer 204 of a wireless communications system, according to embodiments herein. It may be that in some wireless communications systems (e.g., 5G wireless communications systems, LTE wireless communications systems, etc.), the arrangement of the coverage layer 102 and the data layer 104 together represent the coordinated use of multiple cells as cells are understood/defined within that wireless communication system. This may be referred to herein as a “multiple cell coordination” perspective.

Under the multiple cell coordination model, a UE may see each layer as made up of one or more cells. For example, as illustrated in FIG. 2, the coverage layer 202 is provided by a coverage cell 206, and the data layer 204 is provided by a plurality of (distinct) data cells 208 through 222.

Note that the use of a single coverage cell 206 in the coverage layer 102 is given by way of example and not by way of limitation. It is contemplated that in some cases more than one coverage cell may be used as part of the coverage layer 202. Further note that the number of the data cells data cell 208 through 222 is also given by way of example and not by way of limitation. It is contemplated that in some cases fewer (including, e.g., one) or more data cells may be used as part of the data layer 104.

Further, while only a single data layer 204 has been expressly illustrated, it is contemplated that one or more additional data layers may operate a multiple cell coordination model (e.g., in conjunction with the coverage layer 102 and the data layer 104). These one or more additional data layers may each use one or more cells.

Note that under the multiple cell coordination model, the cells of a same layer (e.g., cells of the coverage layer 202, cells of a data layer such as the data layer 204) may operate on same frequency, or on different frequencies within the same band, or on different bands, etc.

Under the multiple cell coordination model, the UE may first camp on a coverage cell of the coverage layer 202 (e.g., the coverage cell 206). Then, in the case that the UE wants to operate on one of the data cells 208 through 222 in the data layer 204, the UE acquires the relevant information for this action from the coverage cell 206 in the coverage layer 202. Accordingly, the UE may receive (via the coverage cell 206) configuration information that indicates the association between the cells 208 through 222 in the data layer with the coverage layer 202. This may include frequency information and/or other cell information for the data cells 208 through 222 of the data layer.

The UE may then begin to operate in a selected data cell of the data layer 204 using this information. In some cases, the UE may begin this operation with the selected data cell of the data layer 204 based on conditions/rules that may be configured by the network.

In other cases, the UE may begin to use a data cell as explicitly directed by the network (e.g., the UE may begin to use to a specific cell and/or frequency directed by the network). In such cases, if the indicated information is cell and frequency, the UE can directly go to the indicated frequency and find the indicated cell on that frequency. In other such cases, if the indicated information is frequency (without specific cell information), the UE will go to the indicated frequency, and then imitate a UE search (e.g., a downlink (DL) sync) for corresponding cell info.

IDLE/INACTIVE UE Operation within Multi-Layer Models

Embodiments for paging reception at an IDLE/INACTIVE UE operating within a multi-layer model are now discussed.

Paging transmission by the network can be performed on either a coverage layer or a data layer. In some cases, the network may transmit non-UE-specific paging in the coverage layer. Further, the network may transmit UE specific paging in either the data layer or the coverage layer.

The network may deliver system information (SI) change, an earthquake and tsunami warning service (ETWS) indication, and/or a paging wake up signal (WUS) on the coverage layer. Further, the network may distribute UE-specific paging amongst the coverage layer and/or the data layer(s) (e.g., according to some configured and/or predefined rule).

The UE may be configured to monitor for paging for an SI change and/or an ETWS indication, etc. on the coverage layer. Then, when the UE receives such paging, the UE can start to acquire relevant SI according to the configuration provided by the network in such paging.

In the case of UE-specific paging, it may be that the UE's paging occasions (POs) can be distributed across the layers (e.g., across the control layer and the data layer(s)). The UE may identify these POs with a formula based on the PO configuration information received from the network. Accordingly, it may be understood that:

$$PO [ Time , Layer ] = Function ( UE\_ID , paging cycle , paging offset ) .$$

Based on such a formula, the UE is enabled to determine layer and time of the UE's POs, and is thus enabled to monitor for paging.

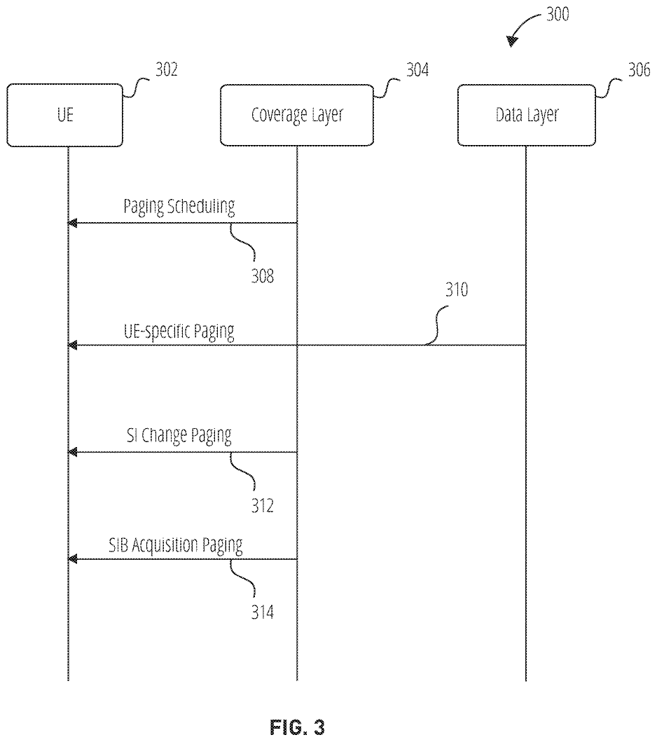

FIG. 3 illustrates a flow diagram 300 for paging operation for a UE 302 operating within a multi-layer model having a coverage layer 304 and a data layer 306, according to embodiments herein. The flow diagram 300 illustrates that the UE 302 receives paging scheduling 308 from a coverage layer 304. The paging scheduling 308 may instruct the UE in the manner of receiving subsequent paging, such as the UE-specific paging 310, the paging for SI change 312, and the paging for emergency SIB acquisition 314.

The flow diagram 300 further illustrates that the UE 302 receives UE-specific paging 310 from a data layer 306 (e.g., according to the paging scheduling 308).

The flow diagram 300 further illustrates that the UE 302 receives paging for SI change 312 from the coverage layer 304 (e.g., according to the paging scheduling 308).

The flow diagram 300 further illustrates that the UE 302 receives paging for emergency SIB acquisition 314 from the coverage layer 304 (e.g., according to the paging scheduling 308).

Embodiments for SI reception at an IDLE/INACTIVE UE operating within a multi-layer model are now discussed.

In some embodiments, an SI transmission can be delivered on either a coverage layer or a data layer, depending on a network configuration. It may be that different SI types are delivered on different corresponding layers. For example, it may be that a master information block (MIB) and a system information block (SIB) 1 (SIB1) (which are treated as essential SI in some wireless communication systems) are delivered on a coverage layer, while other SIBs may be delivered on either a data layer or the coverage layer.

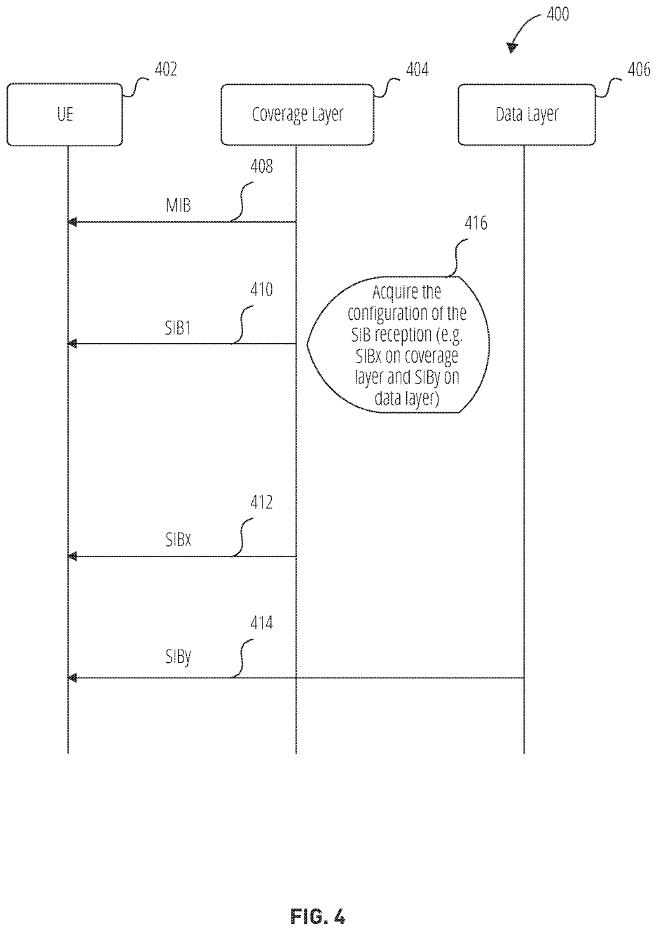

FIG. 4 illustrates a flow diagram 400 for SI reception at a UE 402 operating within a multi-layer model having a coverage layer 404 and a data layer 406, according to embodiments herein. As illustrated, the MIB 408 and a SIB1 410 may be received on the coverage layer 404. As illustrated, the SIB1 410 may include a configuration for SIB reception (e.g., for SIBs other than the SIB1 410). Accordingly, with the receipt of the SIB1 410, the UE 402 acquires 416 the configuration for SIB reception.

This informs the UE 402 of the applicable layer on which those SIBs may be received. For example, corresponding to the embodiment illustrated in FIG. 4, the SIB1 410 informs the UE 402 that SIBx 412 can be received from the coverage layer 404 and that SIBy 414 can be received on the data layer 406. This information enables the UE 402 to acquire the SIBx 412 from the coverage layer 404 and/or the SIBy 414 from the data layer 406, as illustrated.

As described herein, it may be in some embodiments that there are additional data layers (e.g., beyond the single data layer 406 illustrated in FIG. 4). In such cases, the SIB1 410 informs the UE of any SIB(s) that are located on such data layers as well. Accordingly, it will be understood that the UE is thereby enable to receive any such SIB(s) from such additional data layer(s), in addition to the reception of, for example, the SIBx 412 from the coverage layer 404 and the SIBy 414 from the (first) data layer 406.

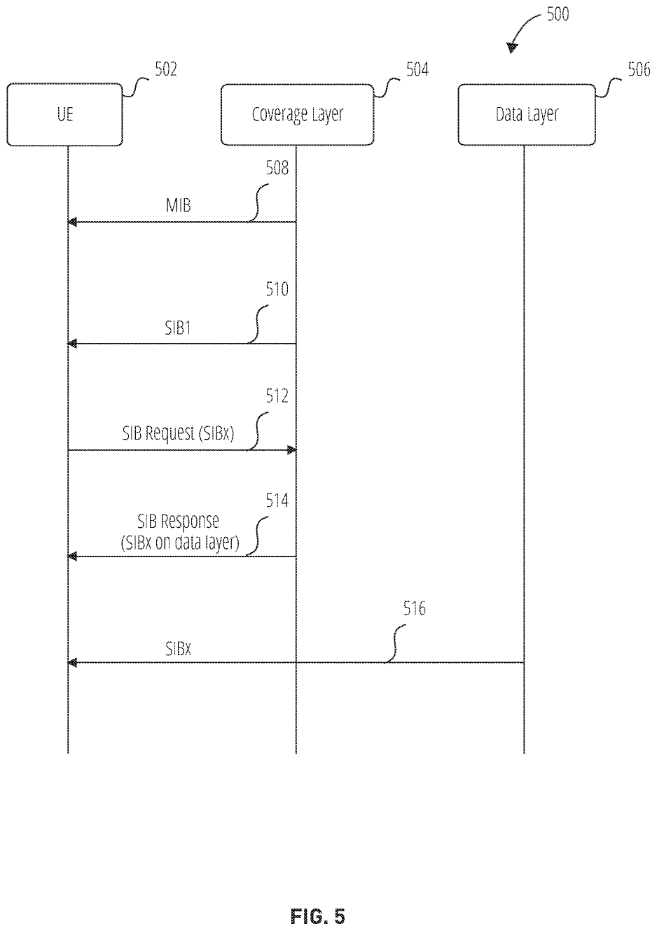

FIG. 5 illustrates a flow diagram 500 for SI reception at a UE 502 operating within a multi-layer model having a coverage layer 504 and a data layer 506, according to embodiments herein.

As illustrated, the UE 502 may first receive the MIB 508 and the SIB1 510 from the coverage layer. Then, the UE may send a request for a particular SIB (e.g., other than SIB1). In the embodiment of FIG. 5, the UE 502 sends on the coverage layer 504 an SIB request 512 for SIBx. In some embodiments, this request may be sent as part of a random access channel (RACH) procedure with the network on the coverage layer 504.

In response, the coverage layer 504 may respond to inform the UE 502 the layer upon which the requested SIB may be received, enabling the UE to receive the requested SIB on the indicated layer. In the embodiment of FIG. 5, the UE 502 receives the SIB response 514 that informs the UE that SIBx may be found on the data layer 506. The UE is accordingly enabled to receive SIBx 516 from the data layer 506, as illustrated.

Note that the requested SIB may be broadcast from layers other than the data layer 506, such as the coverage layer 504 or an additional data layer (unillustrated). A response from the coverage layer 504 analogous to that of the SIB request 512 for one of these SIBs is capable of informing the UE 502 regarding the presence of SIBs on these other layers, such that the UE may receive a SIB from one of these other layers.

The UE 502 may send multiple requests (analogous to the SIB request 512) to identify layers for multiple SIBs.

Embodiments for radio resource management (RRM) measurements at an IDLE/INACTIVE UE operating within a multi-layer model are now discussed.

A process for a basic RRM measurement is now described. The basic RRM measurement may use a coverage layer. When using the cell model, this may mean that an RRM measurement is taken on each of a coverage layer of a serving cell and a coverage layer of a neighbor cell. Under the multiple cell coordination model, this may meant that an RRM measurement is taken on each of a first coverage layer cell for a first set of coordinated cells and a second coverage layer cell for a second set of coordinated cells.

These RRM measurements enable the UE to select between the two cells (in whichever case), such that the UE may perform cell selection/reselection between them.

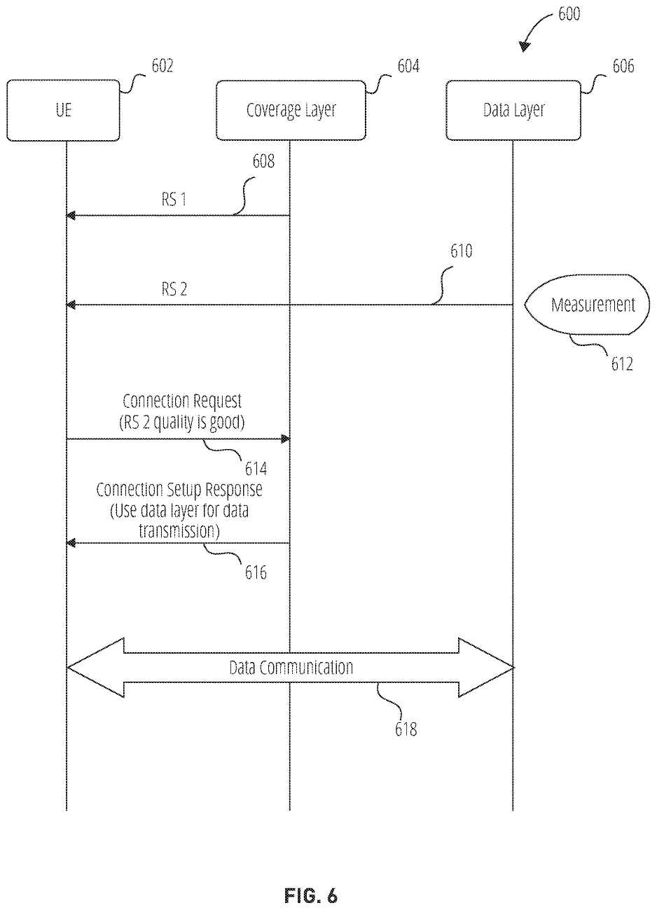

A process for an enhanced RRM measurement for a data layer is now described. FIG. 6 illustrates a flow diagram 600 for the performance and use of an enhanced RRM measurement by a UE 602 operating within a multi-layer model having a coverage layer 604 and a data layer 606, according to embodiments herein.

The network may configure the UE to perform a measurement of a RS on a data layer. In an example embodiment corresponding to FIG. 6, the first RS 608 is received at the UE 602 on the first RS 608 and the second RS 610 is received at the UE 602 on the data layer 606. The network has configured the UE 602 to perform the measurement 612 of the second RS 610 as received on the data layer 606.

The UE may store the reference signal measurement corresponding to one or more data layer(s), and later use stored reference signal measurements when connecting (e.g., performing initial access) to a cell/to a set of coordinated cells using those data layer(s) by communicating this information to a coverage layer 604. For example, as illustrated in FIG. 6, the connection request 614 sent from the UE 602 to the coverage layer 604 may indicate that the second RS 610 (as measured during the measurement 612) is of a good quality.

The reference signal measurement information provided by a UE to a coverage layer may assist the network in assigning an appropriate data layer to the UE. For example, as illustrated in FIG. 6, in response to the connection request 614, the coverage layer 604 replies with a connection setup response 616 indicating that the UE 602 should use the data layer 606 (which was measured at measurement 612 with a good quality) to perform the data communication 618. The UE then proceeds to perform the data communication 618 using the data layer 606 as assigned by the network.

Embodiments for RACH use at an IDLE/INACTIVE UE operating within a multi-layer model are now discussed.

It may be that different RACH types can be configured corresponding to the one or more of the various layer types based on different rules. For example, it may be that a RACH procedure corresponding to an SI request (e.g., as was discussed in relation to FIG. 5) is configured to be performed on the coverage layer.

As another example, it may be that for UE-specific initial access, a corresponding RACH procedure may be configured to be restricted to the coverage layer (e.g., may be required to occur on the coverage layer per configuration).

In other instances for UE-specific initial access, a corresponding RACH procedure may be configured to occur on a layer determined by a rule. For example, in a first case, such a rule may cause the UE to select a random layer from the coverage layer and its associated data layer(s) (or alternatively from only the data layer(s) associated with the coverage layer) with which to perform the RACH procedure with the network.

In another case, the rule may cause the UE to select a configured one of the coverage layer and its associated data layer(s) based on a UE group to which the UE belongs. Configuration information indicating the configured layer for the UE group to which the UE belongs may be delivered to the UE by the network. Then, a UE of a first UE group using this configuration information may perform a RACH procedure with the network on a first configured layer for the first UE group from among the coverage layer and its associated data layer(s).

Note that a second UE of a second UE group using this (same) configuration may perform a RACH procedure with the network on a second configured layer for the second UE group (that is different than the first configured layer) from among the coverage layer and its associated data layer(s).

The group to which the UE belongs may be determined based on, for example, a temporary mobile subscriber identity (TMSI) of the UE.

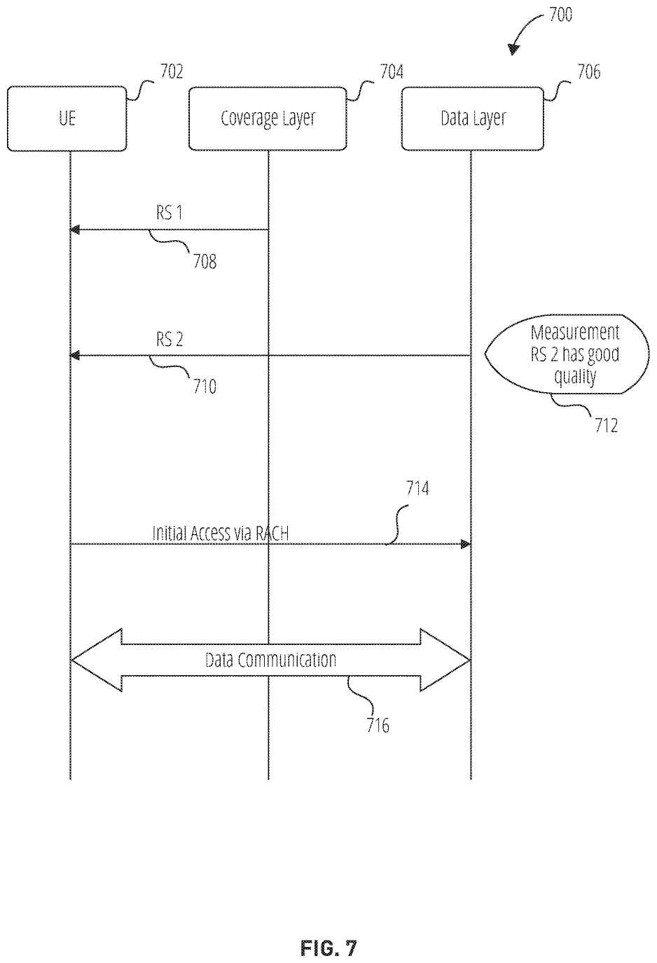

In another case, the rule may cause the UE to trigger a RACH procedure with a layer that has been measured and is known to have a good quality (e.g., where the measurement occurred the manner that was described in relation to FIG. 6). FIG. 7 illustrates a flow diagram 700 for the use of a RACH procedure by a UE 702 operating within a multi-layer model having a coverage layer 704 and a data layer 706, according to embodiments herein.

As illustrated, the UE 702 receives the first RS 708 from the coverage layer 704 and the second RS 710 from the data layer 706. Based on its measurement 712 of the second RS 710 and the known good quality of the second RS 710, the UE 702 triggers the RACH procedure 714 (e.g., for initial access) with the network over the data layer 706.

Once the RACH procedure (e.g., for initial access) according to any of the cases described is completed with the network, the UE may perform data communication with/between itself and the network on the layer that was used for the RACH procedure. As one example, in the embodiment of FIG. 5 describing an example case of using RS measurement as has been described, once the RACH procedure 714 is completed, the UE 702 performs data communication 716 with the network on the data layer 706 corresponding to the RACH procedure 714, as illustrated.

CONNECTED UE Operation within Multi-Layer Models

When in the CONNECTED mode, it may be that the UE generally performs UE-dedicated data communication on the data layer (note, however, that a general tendency for the use of the data layer for such transmissions generally does not preclude the ability of the system to select the coverage layer for such transmissions either additionally and/or alternatively to the use of the data layer).

For a data layer with multiple transmission reception point (TRP)/cell deployment (as the case may be), the network may use a layer 1 (L1) channel state information (CSI) report and/or a layer 3 (L3) measurement report to switch the TRP/cell and transmit data to the UE.

Note that in some cases, the network can schedule the UE to the coverage layer or the other data layers (if such other data layers are configured).

In some cases of a UE in CONNECTED mode that is/has been communicating with the network via a data layer, when the UE link on data layer is broken, UE may fall back to the coverage layer for link recovery.

An RRM measurement may dependent on the applicable network configuration. For example, cell level mobility may be based on a coverage layer based measurement result. Then, intra-data layer mobility can be based on a L1/layer 2 (L2)/L3 measurement report of the data layers.

While the UE operates on a data layer, the UE may relax (e.g., perform less frequently) and/or stop the measurement on coverage layer. When the data layer link then becomes broken, the UE may apply a stricter (more frequent) measurement requirement and/or (re) start the measurement on coverage layer.

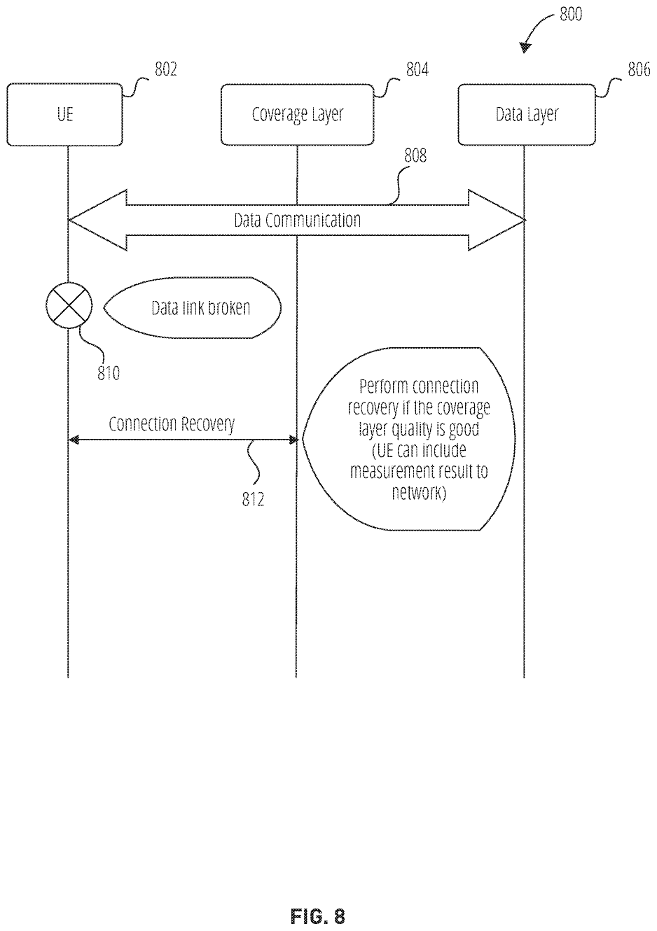

FIG. 8 illustrates a flow diagram 800 for a connection recovery procedure by a UE 802 operating within a multi-layer model having a coverage layer 804 and a data layer 806, according to embodiments herein. The UE 802 performs data communication 808 with the network using the data layer 806, as illustrated. Then, the data link becomes broken 810. The UE proceeds to perform connection recovery 812 with/to the coverage layer 804 in the case that the coverage layer 804 quality is good. In some cases, the UE may include a measurement result of the coverage layer 804 to the network as part of this process.

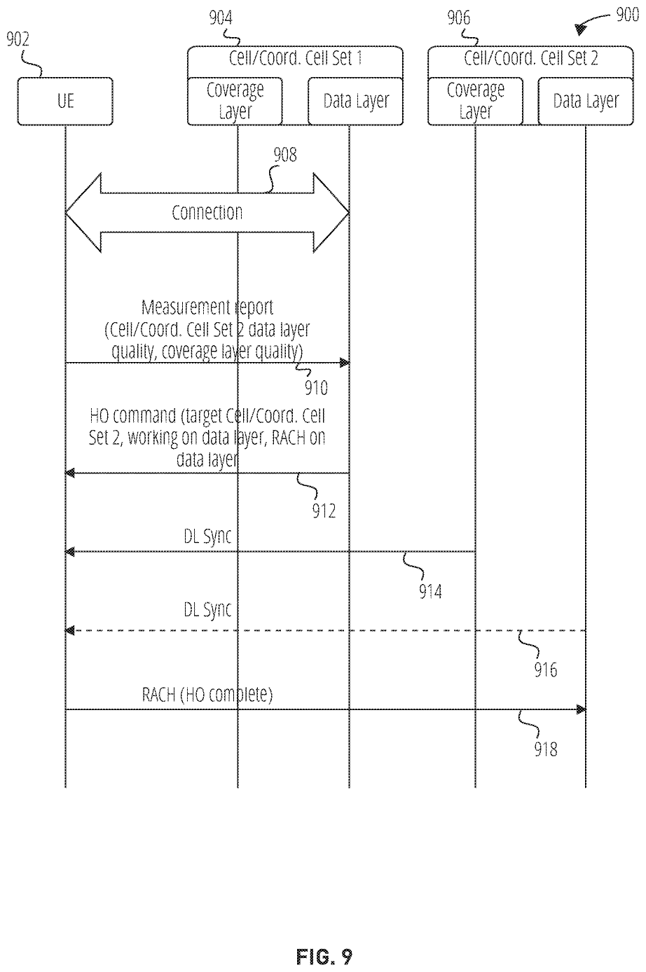

Embodiments for handover for a CONNECTED UE operating within a multi-layer model are now discussed. FIG. 9 illustrates a flow diagram 900 for a handover procedure by a UE 902 operating within a multi-layer model that performs handover from a first cell/first coordinated cell set 904 to a second cell/second coordinated cell set 906, according to embodiments herein.

Note that when the cell model is used by the UE, the first cell/first coordinated cell set 904 and the second cell/second coordinated cell set 906 may each be understood as cells, and when the multiple cell coordination model is used by the UE, the first cell/first coordinated cell set 904 and the second cell/second coordinated cell set 906 may each be understood to be coordinated cell sets.

As illustrated, the UE 902 uses a connection 908 with the network through the first cell/first coordinated cell set 904.

The network may then configure the UE 902 to perform measurement on a coverage layer and a data layer of a neighbor cell/neighbor set of coordinated cells (as the case may be). The UE 902 may proceed to perform such measurements on the second cell/second coordinated cell set 906 according to the network configuration.

The UE 902 may then provide the network with a measurement report 910. The measurement report 910 may report a quality for each of the coverage layer and the data layer of the second cell/second coordinated cell set 906, as illustrated. Note that in cases where the cell model is used, the UE may report on the second cell/second coordinated cell set 906 in one result/report, as in such cases a single measurement identifier (ID) can link to all the measurement results for each layer of a same cell. Further, in cases where the multiple cell coordination model is used, it may be that the network configures the UE to report on each of the measured cells for coverage layer and the data layer of the second cell/second coordinated cell set 906 together. In such cases, the configuration and reporting may be under a single measurement ID, and the corresponding report from the UE may use that single measurement ID to identify and/or group all the measurement results for the same coordinated cell set.

The network may then initiate handover of the UE 902 to the second cell/second coordinated cell set 906. As part of this procedure, the network may provide the UE 902 (via the first cell/first coordinated cell set 904) with a handover (HO) command 912 containing information regarding an assigned/working data layer of the second cell/second coordinated cell set 906 and/or coverage layer information for the second cell/second coordinated cell set 906 (e.g., to be used for RACH), as illustrated.

Upon receiving the HO command 912, the UE 902 acquires a DL sync 914 for the coverage layer of the second cell/second coordinated cell set 906. In some cases, the UE 902 may also acquire a DL sync 916 of the data layer of the second cell/second coordinated cell set 906 (e.g., if the data layer of the second cell/second coordinated cell set 906 and the coverage layer of the second cell/second coordinated cell set 906 are asynchronous).

Then, the UE 902 performs a HO complete message transmission as part of a RACH procedure 918 with the second cell/second coordinated cell set 906, as illustrated. Note that while FIG. 9 illustrates that this occurs with the illustrated data layer of the second cell/second coordinated cell set 906, it could in alternative embodiments occur with the coverage layer of the second cell/second coordinated cell set 906, as based on a network configuration, as predefined at the UE, or as based on a UE selection.

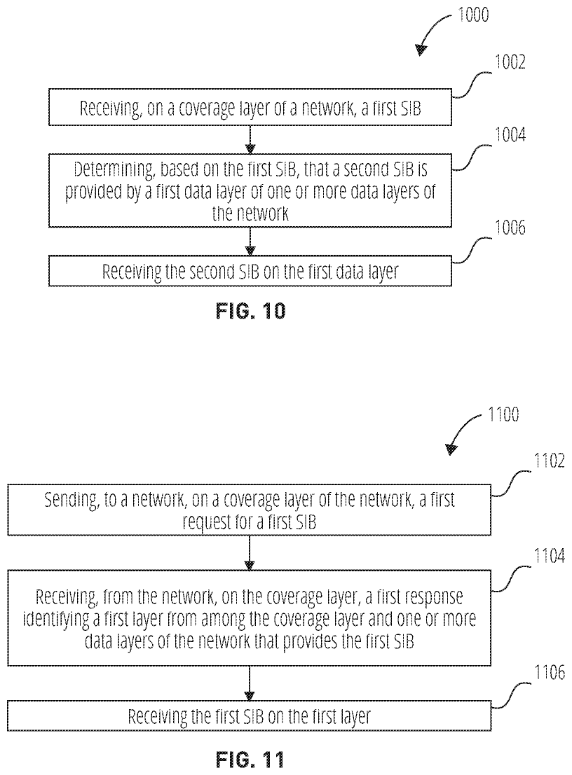

FIG. 10 illustrates a method 1000 of a UE, according to embodiments herein. The method 1000 includes receiving 1002, on a coverage layer of a network, a first SIB.

The method 1000 further includes determining 1004, based on the first SIB, that a second SIB is provided by a first data layer of one or more data layers of the network.

The method 1000 further includes receiving 1006 the second SIB on the first data layer.

In some embodiments, the method 1000 further includes determining, based on the first SIB, that a third SIB is provided by the coverage layer and receiving the third SIB on the coverage layer.

In some embodiments, the method 1000 further includes determining, based on the first SIB, that a third SIB is provided by a second data layer of the one or more data layers and receiving the third SIB on the second data layer.

In some embodiments, the method 1000 further includes selecting a random layer from among the coverage layer and the one or more data layers, performing a RACH procedure with the network on the random layer, and performing data communication with the network on the random layer after completing the RACH procedure with the network on the random layer.

In some embodiments, the method 1000 includes selecting a random layer from among the one or more data layers, performing a RACH procedure with the network on the random layer and performing data communication with the network on the random layer after completing the RACH procedure with the network on the random layer.

In some embodiments, the method 1000 further includes receiving, from the network, configuration information indicating a configured layer from among the coverage layer and the one or more data layers, performing a RACH procedure with the network on the configured layer, and performing data communication with the network on the configured layer after completing the RACH procedure with the network on the configured layer.

In some embodiments, the method 1000 further includes identifying a high quality data layer from among the one or more data layers based on a measurement of the high quality data layer, performing a RACH procedure with the network on the high quality data layer, and performing data communication with the network on the high quality data layer after completing the RACH procedure with the network on the high quality data layer.

In some embodiments of the method 1000, each of the coverage layer and the one or more data layers are provided by a same cell of the network.

In some embodiments of the method 1000, the coverage layer is provided by a first cell of the network and the data layer is provided by a second cell of the network.

FIG. 11 illustrates a method 1100 of a UE, according to embodiments herein. The method 1100 includes sending 1102, to a network, on a coverage layer of the network, a first request for a first SIB.

The method 1100 further includes receiving 1104, from the network, on the coverage layer, a first response identifying a first layer from among the coverage layer and one or more data layers of the network that provides the first SIB.

The method 1100 further includes receiving 1106 the first SIB on the first layer.

In some embodiments, the method 1100 further includes sending, to the network, on the coverage layer, a second request for a second SIB, receiving, from the network, on the coverage layer, a second response identifying a second layer from among the coverage layer and the one or more data layers that provides the second SIB, and receiving the second SIB on the second layer.

In some embodiments of the method 1100, the first request is sent by the UE via a RACH procedure with the network on the coverage layer.

In some embodiments of the method 1100, each of the coverage layer and the one or more data layers are provided by a same cell of the network.

In some embodiments of the method 1100, the coverage layer provided by a first cell of the network and a first data layer of the one or more data layers is provided by a second cell of the network.

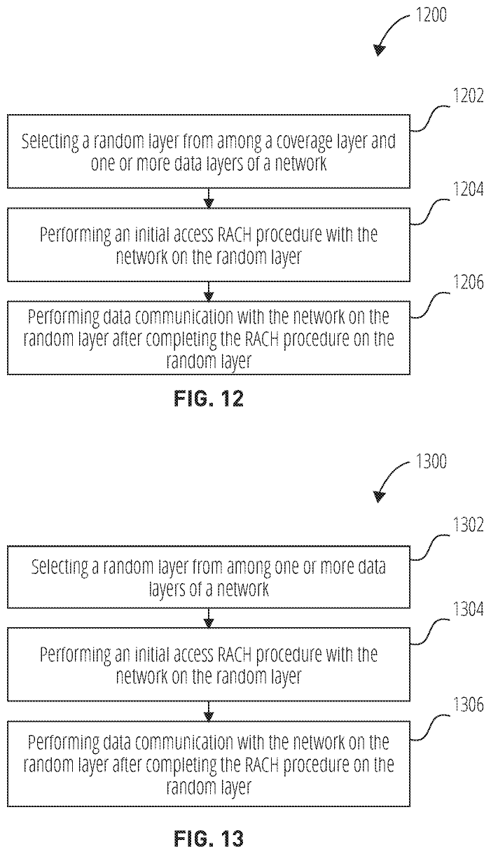

FIG. 12 illustrates a method 1200 of a UE, according to embodiments herein. The method 1200 includes selecting 1202 a random layer from among a coverage layer and one or more data layers of a network.

The method 1200 further includes performing 1204 an initial access RACH procedure with the network on the random layer.

The method 1200 further includes performing 1206 data communication with the network on the random layer after completing the RACH procedure on the random layer.

FIG. 13 illustrates a method 1300 of a UE, according to embodiments herein. The method 1300 includes selecting 1302 a random layer from among one or more data layers of a network.

The method 1300 further includes performing 1304 an initial access RACH procedure with the network on the random layer.

The method 1300 further includes performing 1306 data communication with the network on the random layer after completing the RACH procedure on the random layer.

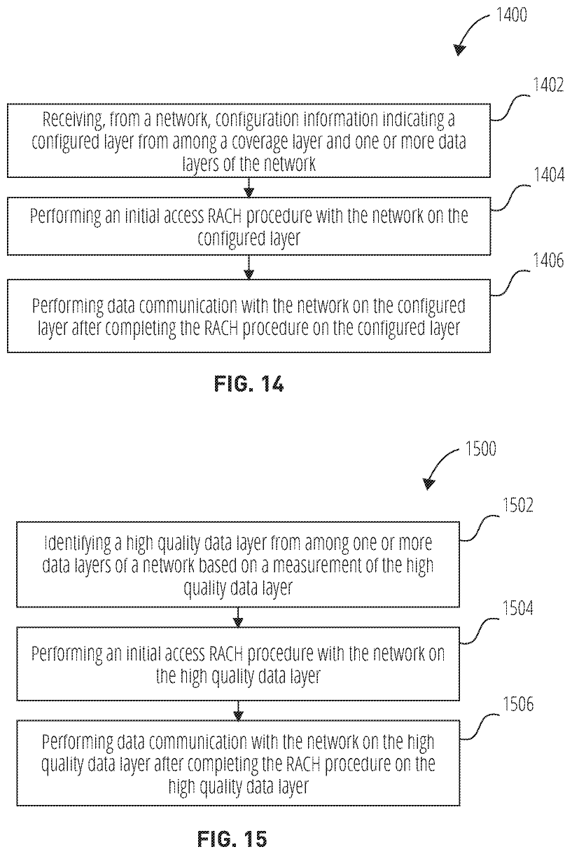

FIG. 14 illustrates a method 1400 of a UE, according to embodiments herein. The method 1400 includes receiving 1402, from a network, configuration information indicating a configured layer from among a coverage layer and one or more data layers of the network.

The method 1400 further includes performing 1404 an initial access RACH procedure with the network on the configured layer.

The method 1400 further includes performing 1406 data communication with the network on the configured layer after completing the RACH procedure on the configured layer.

FIG. 15 illustrates a method of a UE, according to embodiments herein. The method 1500 includes identifying 1502 a high quality data layer from among one or more data layers of a network based on a measurement of the high quality data layer.

The method 1500 further includes performing 1504 an initial access RACH procedure with the network on the high quality data layer.

The method 1500 further includes performing 1506 data communication with the network on the high quality data layer after completing the RACH procedure on the high quality data layer.

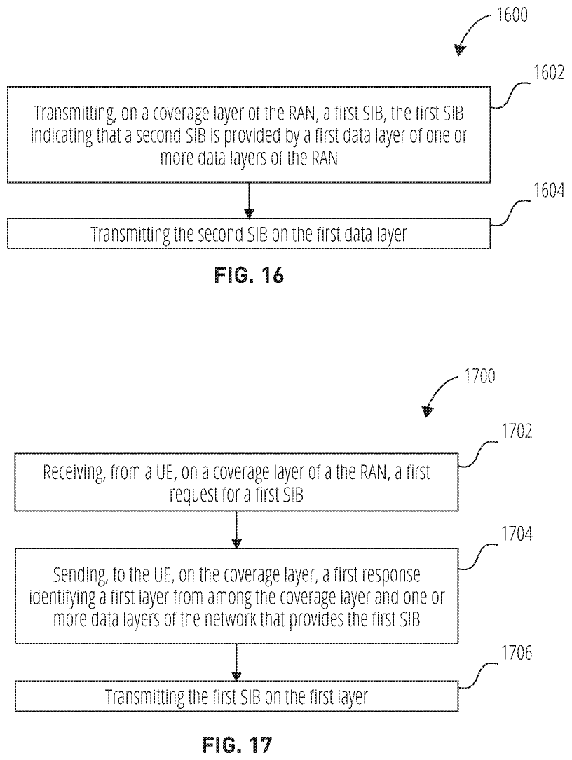

FIG. 16 illustrates a method 1600 of a RAN, according to embodiments herein. The method 1600 includes transmitting 1602, on a coverage layer of the RAN, a first SIB, the first SIB indicating that a second SIB is provided by a first data layer of one or more data layers of the RAN.

The method 1600 further includes transmitting 1604 the second SIB on the first data layer.

In some embodiments of the method 1600, the first SIB indicates that a third SIB is provided by the coverage layer, and further comprising transmitting the third SIB on the coverage layer.

In some embodiments of the method 1600, the first SIB indicates that a third SIB is provided by a second data layer of the one or more data layers, and further comprising transmitting the third SIB on the second data layer.

In some embodiments, the method 1600 further includes performing a RACH procedure with a UE on the coverage layer, and performing data communication with the UE on the coverage layer after completing the RACH procedure with the UE on the coverage layer.

In some embodiments, the method 1600 further includes performing a RACH procedure with a UE on a UE-selected data layer of the one or more data layers and performing data communication with the UE on the UE-selected layer after completing the RACH procedure with the UE on the UE-selected data layer.

In some embodiments, the method 1600 further includes sending, to a UE, configuration information indicating a configured layer from among the coverage layer and the one or more data layers, performing an initial access RACH procedure with the UE on the configured layer, and performing data communication with the UE on the configured layer after completing the RACH procedure with the UE on the configured layer.

In some embodiments of the method 1600, each of the coverage layer and the one or more data layers are provided by a same cell of the RAN.

In some embodiments of the method 1600, the coverage layer provided by a first cell of the RAN and the data layer is provided by a second cell of the RAN.

FIG. 17 illustrates a method 1700 of a RAN, according to embodiments herein. The method 1700 includes receiving 1702, from a UE, on a coverage layer of a the RAN, a first request for a first SIB.

The method 1700 further includes sending 1704, to the UE, on the coverage layer, a first response identifying a first layer from among the coverage layer and one or more data layers of the network that provides the first SIB.

The method 1700 further includes transmitting 1706 the first SIB on the first layer.

In some embodiments, the method 1700 further includes receiving, from the UE, on the coverage layer, a second request for a second SIB, sending, to the UE, on the coverage layer, a second response identifying a second layer from among the coverage layer and the one or more data layers that provides the second SIB, and transmitting the second SIB on the second layer.

In some embodiments of the method 1700, the first request is received at the RAN via a RACH procedure with the UE on the coverage layer.

In some embodiments, the method 1700 further includes performing a RACH procedure with the UE on the coverage layer and performing data communication with the UE on the coverage layer after completing the RACH procedure with the UE on the coverage layer.

In some embodiments, the method 1700 further includes performing an initial access RACH procedure with the UE on an UE-selected data layer of the one or more data layers and performing data communication with the UE on the UE-selected data layer after completing the RACH procedure with the UE on the UE-selected data layer.

In some embodiments, the method 1700 further includes sending, to the UE, configuration information indicating a configured layer from among the coverage layer and the one or more data layers, performing an initial access RACH procedure with the UE on the configured layer, and performing data communication with the UE on the configured layer after completing the RACH procedure with the UE on the configured layer.

In some embodiments of the method 1700, each of the coverage layer and the one or more data layers are provided by a same cell of the RAN.

In some embodiments of the method 1700, the coverage layer provided by a first cell of the RAN and a first data layer of the one or more data layers is provided by a second cell of the RAN.

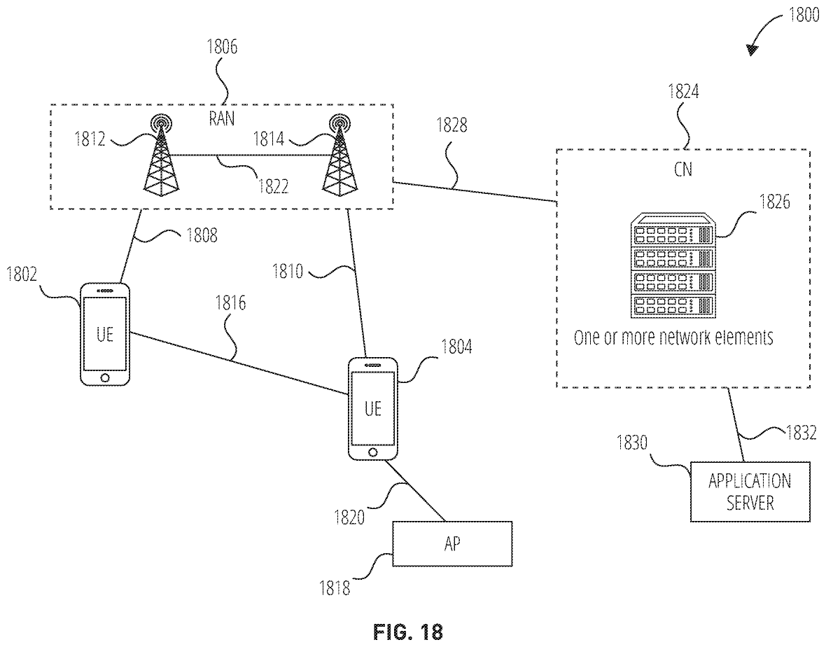

FIG. 18 illustrates an example architecture of a wireless communication system 1800, according to embodiments disclosed herein. The following description is provided for an example wireless communication system 1800 that operates in conjunction with the LTE system standards and/or 5G or NR system standards as provided by 3GPP technical specifications.

As shown by FIG. 18, the wireless communication system 1800 includes UE 1802 and UE 1804 (although any number of UEs may be used). In this example, the UE 1802 and the UE 1804 are illustrated as smartphones (e.g., handheld touchscreen mobile computing devices connectable to one or more cellular networks), but may also comprise any mobile or non-mobile computing device configured for wireless communication.

The UE 1802 and UE 1804 may be configured to communicatively couple with a RAN 1806. In embodiments, the RAN 1806 may be NG-RAN, E-UTRAN, etc. The UE 1802 and UE 1804 utilize connections (or channels) (shown as connection 1808 and connection 1810, respectively) with the RAN 1806, each of which comprises a physical communications interface. The RAN 1806 can include one or more base stations (such as base station 1812 and base station 1814) that enable the connection 1808 and connection 1810.

In this example, the connection 1808 and connection 1810 are air interfaces to enable such communicative coupling, and may be consistent with RAT(s) used by the RAN 1806, such as, for example, an LTE and/or NR.

In some embodiments, the UE 1802 and UE 1804 may also directly exchange communication data via a sidelink interface 1816. The UE 1804 is shown to be configured to access an access point (shown as AP 1818) via connection 1820. By way of example, the connection 1820 can comprise a local wireless connection, such as a connection consistent with any IEEE 802.11 protocol, wherein the AP 1818 may comprise a Wi-Fi® router. In this example, the AP 1818 may be connected to another network (for example, the Internet) without going through a CN 1824.

In embodiments, the UE 1802 and UE 1804 can be configured to communicate using orthogonal frequency division multiplexing (OFDM) communication signals with each other or with the base station 1812 and/or the base station 1814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 1812 or base station 1814 may be implemented as one or more software entities running on server computers as part of a virtual network. In addition, or in other embodiments, the base station 1812 or base station 1814 may be configured to communicate with one another via interface 1822. In embodiments where the wireless communication system 1800 is an LTE system (e.g., when the CN 1824 is an EPC), the interface 1822 may be an X2 interface. The X2 interface may be defined between two or more base stations (e.g., two or more eNBs and the like) that connect to an EPC, and/or between two eNBs connecting to the EPC. In embodiments where the wireless communication system 1800 is an NR system (e.g., when CN 1824 is a 5GC), the interface 1822 may be an Xn interface. The Xn interface is defined between two or more base stations (e.g., two or more gNBs and the like) that connect to 5GC, between a base station 1812 (e.g., a gNB) connecting to 5GC and an eNB, and/or between two eNBs connecting to 5GC (e.g., CN 1824).

The RAN 1806 is shown to be communicatively coupled to the CN 1824. The CN 1824 may comprise one or more network elements 1826, which are configured to offer various data and telecommunications services to customers/subscribers (e.g., users of UE 1802 and UE 1804) who are connected to the CN 1824 via the RAN 1806. The components of the CN 1824 may be implemented in one physical device or separate physical devices including components to read and execute instructions from a machine-readable or computer-readable medium (e.g., a non-transitory machine-readable storage medium).

In embodiments, the CN 1824 may be an EPC, and the RAN 1806 may be connected with the CN 1824 via an S1 interface 1828. In embodiments, the S1 interface 1828 may be split into two parts, an S1 user plane (S1-U) interface, which carries traffic data between the base station 1812 or base station 1814 and a serving gateway (S-GW), and the S1-MME interface, which is a signaling interface between the base station 1812 or base station 1814 and mobility management entities (MMEs).

In embodiments, the CN 1824 may be a 5GC, and the RAN 1806 may be connected with the CN 1824 via an NG interface 1828. In embodiments, the NG interface 1828 may be split into two parts, an NG user plane (NG-U) interface, which carries traffic data between the base station 1812 or base station 1814 and a user plane function (UPF), and the S1 control plane (NG-C) interface, which is a signaling interface between the base station 1812 or base station 1814 and access and mobility management functions (AMFs).

Generally, an application server 1830 may be an element offering applications that use internet protocol (IP) bearer resources with the CN 1824 (e.g., packet switched data services). The application server 1830 can also be configured to support one or more communication services (e.g., VoIP sessions, group communication sessions, etc.) for the UE 1802 and UE 1804 via the CN 1824. The application server 1830 may communicate with the CN 1824 through an IP communications interface 1832.

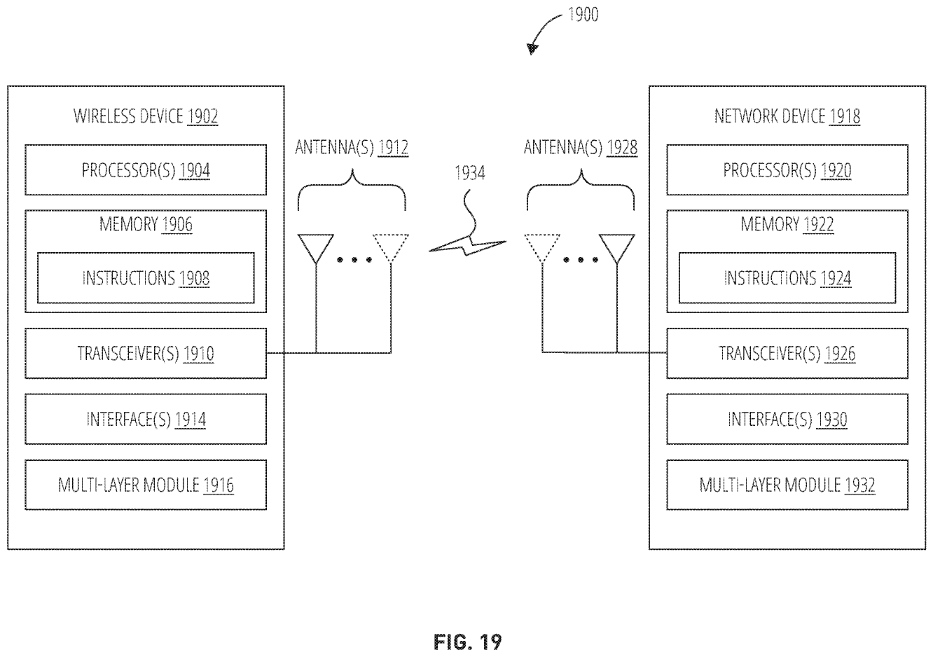

FIG. 19 illustrates a system 1900 for performing signaling 1934 between a wireless device 1902 and a network device 1918, according to embodiments disclosed herein. The system 1900 may be a portion of a wireless communications system as herein described. The wireless device 1902 may be, for example, a UE of a wireless communication system. The network device 1918 may be, for example, a base station (e.g., an eNB or a gNB) of a wireless communication system.

The wireless device 1902 may include one or more processor(s) 1904. The processor(s) 1904 may execute instructions such that various operations of the wireless device 1902 are performed, as described herein. The processor(s) 1904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 1902 may include a memory 1906. The memory 1906 may be a non-transitory computer-readable storage medium that stores instructions 1908 (which may include, for example, the instructions being executed by the processor(s) 1904). The instructions 1908 may also be referred to as program code or a computer program. The memory 1906 may also store data used by, and results computed by, the processor(s) 1904.

The wireless device 1902 may include one or more transceiver(s) 1910 that may include radio frequency (RF) transmitter and/or receiver circuitry that use the antenna(s) 1912 of the wireless device 1902 to facilitate signaling (e.g., the signaling 1934) to and/or from the wireless device 1902 with other devices (e.g., the network device 1918) according to corresponding RATs.

The wireless device 1902 may include one or more antenna(s) 1912 (e.g., one, two, four, or more). For embodiments with multiple antenna(s) 1912, the wireless device 1902 may leverage the spatial diversity of such multiple antenna(s) 1912 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 1902 may be accomplished according to precoding (or digital beamforming) that is applied at the wireless device 1902 that multiplexes the data streams across the antenna(s) 1912 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 1902 may implement analog beamforming techniques, whereby phases of the signals sent by the antenna(s) 1912 are relatively adjusted such that the (joint) transmission of the antenna(s) 1912 can be directed (this is sometimes referred to as beam steering).

The wireless device 1902 may include one or more interface(s) 1914. The interface(s) 1914 may be used to provide input to or output from the wireless device 1902. For example, a wireless device 1902 that is a UE may include interface(s) 1914 such as microphones, speakers, a touchscreen, buttons, and the like in order to allow for input and/or output to the UE by a user of the UE. Other interfaces of such a UE may be made up of made up of transmitters, receivers, and other circuitry (e.g., other than the transceiver(s) 1910/antenna(s) 1912 already described) that allow for communication between the UE and other devices and may operate according to known protocols (e.g., Wi-Fi®, Bluetooth®, and the like).

The wireless device 1902 may include a multi-layer module 1916. The multi-layer module 1916 may be implemented via hardware, software, or combinations thereof. For example, the multi-layer module 1916 may be implemented as a processor, circuit, and/or instructions 1908 stored in the memory 1906 and executed by the processor(s) 1904. In some examples, the multi-layer module 1916 may be integrated within the processor(s) 1904 and/or the transceiver(s) 1910. For example, the multi-layer module 1916 may be implemented by a combination of software components (e.g., executed by a DSP or a general processor) and hardware components (e.g., logic gates and circuitry) within the processor(s) 1904 or the transceiver(s) 1910.

The multi-layer module 1916 may be used for various aspects of the present disclosure, for example, aspects of FIG. 1 through FIG. 17. The multi-layer module 1916 may be configured to perform UE functions for operating a UE in a multi-layer configuration, as described herein.

The network device 1918 may include one or more processor(s) 1920. The processor(s) 1920 may execute instructions such that various operations of the network device 1918 are performed, as described herein. The processor(s) 1920 may include one or more baseband processors implemented using, for example, a CPU, a DSP, an ASIC, a controller, an FPGA device, another hardware device, a firmware device, or any combination thereof configured to perform the operations described herein.

The network device 1918 may include a memory 1922. The memory 1922 may be a non-transitory computer-readable storage medium that stores instructions 1924 (which may include, for example, the instructions being executed by the processor(s) 1920). The instructions 1924 may also be referred to as program code or a computer program. The memory 1922 may also store data used by, and results computed by, the processor(s) 1920.

The network device 1918 may include one or more transceiver(s) 1926 that may include RF transmitter and/or receiver circuitry that use the antenna(s) 1928 of the network device 1918 to facilitate signaling (e.g., the signaling 1934) to and/or from the network device 1918 with other devices (e.g., the wireless device 1902) according to corresponding RATs.

The network device 1918 may include one or more antenna(s) 1928 (e.g., one, two, four, or more). In embodiments having multiple antenna(s) 1928, the network device 1918 may perform MIMO, digital beamforming, analog beamforming, beam steering, etc., as has been described.

The network device 1918 may include one or more interface(s) 1930. The interface(s) 1930 may be used to provide input to or output from the network device 1918. For example, a network device 1918 that is a base station may include interface(s) 1930 made up of transmitters, receivers, and other circuitry (e.g., other than the transceiver(s) 1926/antenna(s) 1928 already described) that enables the base station to communicate with other equipment in a core network, and/or that enables the base station to communicate with external networks, computers, databases, and the like for purposes of operations, administration, and maintenance of the base station or other equipment operably connected thereto.

The network device 1918 may include a multi-layer module 1932. The multi-layer module 1932 may be implemented via hardware, software, or combinations thereof. For example, the multi-layer module 1932 may be implemented as a processor, circuit, and/or instructions 1924 stored in the memory 1922 and executed by the processor(s) 1920. In some examples, the multi-layer module 1932 may be integrated within the processor(s) 1920 and/or the transceiver(s) 1926. For example, the multi-layer module 1932 may be implemented by a combination of software components (e.g., executed by a DSP or a general processor) and hardware components (e.g., logic gates and circuitry) within the processor(s) 1920 or the transceiver(s) 1926.

The multi-layer module 1932 may be used for various aspects of the present disclosure, for example, aspects of FIG. 1 through FIG. 17. The multi-layer module 1932 may be configured to perform network operations for operating the network in a multi-layer configuration, as are described herein.

Embodiments contemplated herein include an apparatus comprising means to perform one or more elements of any of the method 1000 and the method 1100. This apparatus may be, for example, an apparatus of a UE (such as a wireless device 1902 that is a UE, as described herein).

Embodiments contemplated herein include one or more non-transitory computer-readable media comprising instructions to cause an electronic device, upon execution of the instructions by one or more processors of the electronic device, to perform one or more elements of any of the method 1000 and the method 1100. This non-transitory computer-readable media may be, for example, a memory of a UE (such as a memory 1906 of a wireless device 1902 that is a UE, as described herein).

Embodiments contemplated herein include an apparatus comprising logic, modules, or circuitry to perform one or more elements of any of the method 1000 and the method 1100. This apparatus may be, for example, an apparatus of a UE (such as a wireless device 1902 that is a UE, as described herein).

Embodiments contemplated herein include an apparatus comprising: one or more processors and one or more computer-readable media comprising instructions that, when executed by the one or more processors, cause the one or more processors to perform one or more elements of any of the method 1000 and the method 1100. This apparatus may be, for example, an apparatus of a UE (such as a wireless device 1902 that is a UE, as described herein).

Embodiments contemplated herein include a signal as described in or related to one or more elements of any of the method 1000 and the method 1100.

Embodiments contemplated herein include a computer program or computer program product comprising instructions, wherein execution of the program by a processor is to cause the processor to carry out one or more elements of any of the method 1000 and the method 1100. The processor may be a processor of a UE (such as a processor(s) 1904 of a wireless device 1902 that is a UE, as described herein). These instructions may be, for example, located in the processor and/or on a memory of the UE (such as a memory 1906 of a wireless device 1902 that is a UE, as described herein).

Embodiments contemplated herein include an apparatus comprising means to perform one or more elements of any of the method 1600 and the method 1700. This apparatus may be, for example, an apparatus of a base station (such as a network device 1918 that is a base station, as described herein).

Embodiments contemplated herein include one or more non-transitory computer-readable media comprising instructions to cause an electronic device, upon execution of the instructions by one or more processors of the electronic device, to perform one or more elements of any of the method 1600 and the method 1700. This non-transitory computer-readable media may be, for example, a memory of a base station (such as a memory 1922 of a network device 1918 that is a base station, as described herein).

Embodiments contemplated herein include an apparatus comprising logic, modules, or circuitry to perform one or more elements of any of the method 1600 and the method 1700. This apparatus may be, for example, an apparatus of a base station (such as a network device 1918 that is a base station, as described herein).

Embodiments contemplated herein include an apparatus comprising: one or more processors and one or more computer-readable media comprising instructions that, when executed by the one or more processors, cause the one or more processors to perform one or more elements of any of the method 1600 and the method 1700. This apparatus may be, for example, an apparatus of a base station (such as a network device 1918 that is a base station, as described herein).

Embodiments contemplated herein include a signal as described in or related to one or more elements of any of the method 1600 and the method 1700.

Embodiments contemplated herein include a computer program or computer program product comprising instructions, wherein execution of the program by a processing element is to cause the processing element to carry out one or more elements of any of the method 1600 and the method 1700. The processor may be a processor of a base station (such as a processor(s) 1920 of a network device 1918 that is a base station, as described herein). These instructions may be, for example, located in the processor and/or on a memory of the base station (such as a memory 1922 of a network device 1918 that is a base station, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
receiving, on a coverage layer of a network, a first system information block (SIB);
determining, based on the first SIB, that a second SIB is provided by a first data layer of one or more data layers of the network; and
receiving the second SIB on the first data layer.

2. The method of claim 1, further comprising:
determining, based on the first SIB, that a third SIB is provided by the coverage layer; and
receiving the third SIB on the coverage layer.

3. The method of claim 1, further comprising:
determining, based on the first SIB, that a third SIB is provided by a second data layer of the one or more data layers; and
receiving the third SIB on the second data layer.

4. The method of claim 1, further comprising:
selecting a random layer from among the coverage layer and the one or more data layers;
performing a random access channel (RACH) procedure with the network on the random layer; and
performing data communication with the network on the random layer after completing the RACH procedure with the network on the random layer.

5. The method of claim 1, further comprising:
selecting a random layer from among the one or more data layers;
performing a random access channel (RACH) procedure with the network on the random layer; and
performing data communication with the network on the random layer after completing the RACH procedure with the network on the random layer.

6. The method of claim 1, further comprising:
receiving, from the network, configuration information indicating a configured layer from among the coverage layer and the one or more data layers;
performing a random access channel (RACH) procedure with the network on the configured layer; and
performing data communication with the network on the configured layer after completing the RACH procedure with the network on the configured layer.

7. The method of claim 1, further comprising:
identifying a high quality data layer from among the one or more data layers based on a measurement of the high quality data layer;
performing a random access channel (RACH) procedure with the network on the high quality data layer; and
performing data communication with the network on the high quality data layer after completing the RACH procedure with the network on the high quality data layer.

8. The method of claim 1, wherein each of the coverage layer and the one or more data layers are provided by a same cell of the network.

9. The method of claim 1, wherein the coverage layer is provided by a first cell of the network and the data layer is provided by a second cell of the network.

10. A method of a user equipment (UE), comprising:
sending, to a network, on a coverage layer of the network, a first request for a first system information block (SIB);
receiving, from the network, on the coverage layer, a first response identifying a first layer from among the coverage layer and one or more data layers of the network that provides the first SIB; and
receiving the first SIB on the first layer.

11. The method of claim 10, further comprising:
sending, to the network, on the coverage layer, a second request for a second SIB;
receiving, from the network, on the coverage layer, a second response identifying a second layer from among the coverage layer and the one or more data layers that provides the second SIB; and
receiving the second SIB on the second layer.

12. The method of claim 10, wherein the first request is sent by the UE via a random access channel (RACH) procedure with the network on the coverage layer.

13. The method of claim 10, wherein each of the coverage layer and the one or more data layers are provided by a same cell of the network.

14. The method of claim 10, wherein the coverage layer provided by a first cell of the network and a first data layer of the one or more data layers is provided by a second cell of the network.

15-18. (canceled)

19. A method of a radio access network (RAN), comprising:
transmitting, on a coverage layer of the RAN, a first system information block (SIB), the first SIB indicating that a second SIB is provided by a first data layer of one or more data layers of the RAN; and
transmitting the second SIB on the first data layer.

20. The method of claim 19, wherein the first SIB indicates that a third SIB is provided by the coverage layer, and further comprising transmitting the third SIB on the coverage layer.

21. The method of claim 19, wherein the first SIB indicates that a third SIB is provided by a second data layer of the one or more data layers, and further comprising transmitting the third SIB on the second data layer.

22. The method of claim 19, further comprising:
performing a random access channel (RACH) procedure with a user equipment (UE) on the coverage layer; and
performing data communication with the UE on the coverage layer after completing the RACH procedure with the UE on the coverage layer.

23. The method of claim 19, further comprising:
performing a random access channel (RACH) procedure with a user equipment (UE) on a UE-selected data layer of the one or more data layers; and
performing data communication with the UE on the UE-selected layer after completing the RACH procedure with the UE on the UE-selected data layer.

24. The method of claim 19, further comprising:
sending, to a user equipment (UE), configuration information indicating a configured layer from among the coverage layer and the one or more data layers;
performing an initial access random access channel (RACH) procedure with the UE on the configured layer; and
performing data communication with the UE on the configured layer after completing the RACH procedure with the UE on the configured layer.

25-34. (canceled)
